(19) United States
(12) Patent Application Publication
(10) Pub. No.: US 2008/0201198 A1
(43) Pub. Date: Aug. 21, 2008

(54) Method, System and Computer Program Product for Measuring and Tracking Brand Equity

(76) Inventors: Jordan J. Louviere, Cremorne (AU); Timothy Devinney, Ashfield (AU)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/661,878

(22) PCT Filed: Sep. 2, 2005
(86) PCT No.: PCT/AU2005/001337

§ 371 Date: Dec. 12, 2007

(30) Foreign Application Priority Data
Sep. 2, 2004 (AU) 2004905015

(51) Int. Cl. G06Q 10/00

(52) U.S. Cl. 705/10

(57) ABSTRACT

Methods, systems and computer program products for measuring and tracking brand equity are disclosed. According to one embodiment disclosed, a brand equity value for each of a plurality of brands in a market category is obtained (210) and an index value for each of the plurality of brands is calculated (220). Each index value is representative of a difference between a corresponding brand equity value and a reference brand equity value for the market category. A brand equity index for the market category is generated based on the index values (230). The brand equity values may be obtained by identifying key features in the market category, designing choice experiments based on a plurality of brands in the market category and the key features, obtaining data relating to the plurality of brands using the choice experiments, developing choice models from the data, and determining a brand equity value for each of the plurality of brands using the choice models.

### FIELD OF THE INVENTION

The present invention relates to brand equity and more particularly to determining the premium that consumers are willing to pay for a particular brand name.

### BACKGROUND

Brand equity represents the premium that consumers are willing to pay for a particular brand name when all other product and/or service features remain constant. Brands that possess strong equity can charge a premium whereas brands that possess weak equity need to discount to increase market share.

Early conceptual and empirical work relating to brand equity focused on the effects of brands on consumer perceptions of tangible and intangible product attributes. More recently, theories of information economics have been applied to investigate how the impact of product price on consumer utility is moderated by brand credibility. Results indicate that brand credibility decreases price sensitivity.

It is desirable to maximise the potential of brands instead of risking harm to valuable brands (assets) through well-intended but sub-optimal practices. For example, businesses need to understand how their actions and the actions of their competitors will impact on the equity of their brand. While actions such as cost cutting, layoffs, pricing changes and outlet closures may make sense in certain circumstances, such actions should be considered in the interest of overall shareholder equity. There is great potential that such actions could lead to long-term damage in terms of brand assets. Brand owners need to consider how such actions will influence brand equity and thus translate into bottomline performance indicators such as return on investment (ROI), profits, etc.

Accordingly, a need exists for methods and tools to measure and track brand equity. Such methods and tools would advantageously enable targeted measurement of equity premiums for different market segments, thus allowing brand owners to quantify how strategic decisions would influence the equity of their brand. Other benefits may include predicting the effects of competitor actions and environmental changes, comparing and tracking changes in brand equity value, measuring brand equity values for different market segments and predicting how specific actions could influence a market segment, and implementing value pricing.

To be useful, brand equity should be represented in actual monetary terms.

### SUMMARY

Aspects of the present invention provide methods, systems and computer program products for measuring and tracking brand equity.

In accordance with certain aspects, key features in at least one market category are identified, choice experiments are designed based on brands in the at least one market category and the identified features, data relating to the brands is obtained using the choice experiments, choice models are developed from the data and a brand equity value for each of brands is determined using the choice models. The brand equity values may comprise monetary values and the data may be obtained by consumer surveys conducted via the World Wide Web (WWW). The data from the choice experiments may be supplemented with survey data that measures key brand equity concepts such as credibility, consistency and quality.

A brand equity index may be generated based on the brand equity values. The brand equity index may comprise a plurality of relative values, each associated with a corresponding brand equity value and representative of a difference between the corresponding brand equity value and a reference brand equity value for the market category. The reference brand equity value may comprise an average value of the brand equity values of brands in the market category. Each relative value may represent a premium above or a discount below the average value that will enable a brand corresponding to the relative value to achieve an equal share in the market category. The reference brand equity value may be kept secret from recipients of the brand equity index.

### BRIEF DESCRIPTION OF THE DRAWINGS

A small number of embodiments are described hereinafter, by way of example only, with reference to the accompanying drawings in which:

FIG. 1 is a flow diagram of a method for measuring and tracking brand equity;

FIG. 2 is a flow diagram of another method for measuring and tracking brand equity; and

FIG. 3 is a schematic block diagram of a computer system with which embodiments of the present invention may be practiced.

### DETAILED DESCRIPTION

Embodiments of methods, systems and computer program products for measuring and tracking brand equity are described herein. The expected utility of consumers is driven by experience and expectation. Three basic constructs drive brand equity, namely consistency, credibility and quality. To estimate brand equity at a point in time, the constructs may be measured and included in choice models, which may be used to convert estimated utilities into actual monetary values.

### Choice Models

Choice models are based on Random Utility Theory (RUT), which was developed by L. L. Thurstone and published in a well-known paper in the Psychological Review (1927). Thurstone realised that when human beings compare a pair of objects or choice options, such as two shades of the colour red, several times, they will not consistently make the same choice. Thus, if questions about pairs of objects or choice options are asked in a systematic way, an average preference or choice can be estimated with some degree of error:

Uᵢₙ=Vᵢₙ+εᵢₙ (1)

where:
Uᵢₙ is the unobservable or latent utility or preference that an individual n has for option or object i,
Vᵢₙ is the average or mean preference that the individual n associates with option i, and
εᵢₙ is the error associated with the individual n's preference for option i.

It is assumed that the individual n will select the option of highest preference subject to certain constraints such as limited money, limited time, peer pressure, social mores, etc. Because the individual n's decision process cannot be known, the problem is stochastic or probabilistic in nature to an outside observer who is attempting to understand and predict the individual n's choice. The probability that the individual n will select option i from the choice i, j is:

Pn(i|ij)=P[(Vᵢₙ+εᵢₙ)>(Vⱼₙ+εᵢₙ)] (2)

where:
Vᵢₙ, εᵢₙ, and n are as defined hereinbefore, and
i and j are the options in the pair.

The foregoing equation, which applies to pairs only, was extended to allow for multiple choices by Dan McFadden, the winner of the Nobel Prize in Economics in 2000:

Pn(i|Cₙ)=P[(Vᵢₙ+εᵢₙ)>(V₁ₙ+ε₁ₙ)> . . . >(Vⱼₙ+εⱼₙ)] (3)

for all j options in the set of options (offerings) C, faced by the individual n.

The terms Vᵢₙ may be represented by a generalized regression equation such as:

Vᵢₙ=β₀+β₁X₁ᵢ+β₂X₂ᵢ+ . . . +βₖXₖᵢ (4)

where:
X₁ᵢ . . . Xₖᵢ are explanatory variables such as product features, price, etc., and
β₀ . . . βₖ are efficients that are typically determined from consumer choice data.

Numerous other explanatory variables such as characteristics of individuals such as income, age, etc., may be included in equation 4 but would be subscripted with n. Equation 4 is not subscripted with n based on the assumption that the regression parameters apply to all of the individuals in a particular group.

The coefficients are estimated based on choice data or data suitable for modeling choices or preferences from choice experiments. Choice experiments comprise multiple comparison questions designed in sophisticated ways so that features and prices of offerings can be systematically and independently varied across a range of pre-specified comparison sets known as “choice sets”.

A choice experiment generally represents a purposive sample selected from all possible combinations. However, all the possible combinations are occasionally used in what is known as a “complete or full factorial design”. Thus, a choice experiment is merely a vehicle for ensuring that the comparison sets (i.e., the sets about which the questions are asked) are designed in a statistically efficient and reliable manner. This ensures that all the coefficients of interest can be estimated in a similarly efficient and reliable manner. For example, in the case of four choice scenarios involving three options, a certain subset of 16 combinations of choices can be selected, from which all parameters of interest can be estimated, instead of all 4³=64 possible combinations. Thus, choice experiments are usually based on smaller numbers of combinations selected from the complete factorial in order to permit feasible and statistically reliable data collection from which to estimate choice models.

The coefficients, once determined, may be used to predict the probability that any randomly drawn individual n will choose a particular option contained in a particular choice set of options C. The choice model defined by equation 5, hereinafter, is based on the assumption that the errors are distributed as Extreme Value Type 1 random variates (also known as a Gumble, Weibul or Double Exponential distribution):

$$Pn ( i \vert {C}_{n} ) = \frac{exp ( {β}_{0 i} + {β}_{1} {X}_{1 i} + {β}_{2} {X}_{2 i} + … + {β}_{k} {X}_{ki} )}{{\sum }_{j} exp ( {β}_{0 j} + {β}_{1} {X}_{1 j} + {β}_{2} {X}_{2 j} + … + {β}_{k} {X}_{kj} )} \qquad ( 5 )$$

Equation 5 is known as a multinomial logit (MNL) choice model, which can be used to predict the choice probabilities for any competing set of offerings by simply substituting in the values of the explanatory variables associated with each of the j choice options in each set C to generate predicted choice probabilities.

The MNL model is derived from random utility theory (RUT) in economics and psychology as explained in “Stated Choice Methods: Analysis and Application”, Louviere J., Hensher D. and Swait J., Cambridge, UK, Cambridge University Press, 2^{nd} Printing, 2003, Chapter 2, pp. 20-82, incorporated herein by reference.

In certain examples described hereinafter, the constants were estimated using a method of simple average, which employs the technique of least-squares regression. This method is described in “Design and Analysis of Simulated Consumer Choice or Allocation Experiments”, Louviere J. and Woodworth G., Journal of Marketing Research, 20 Nov. 1983. In other examples described hereinafter, a more complex method using maximum likelihood estimation was used. Descriptions of such a method for estimation using maximum likelihood estimation are described in a paper entitled “Design and Analysis of Simulated Consumer Choice or Allocation Experiments”, Louviere J. and Woodworth G., Journal of Marketing Research, 20 Nov. 1983, 350-367 and in the text “Stated Choice Methods: Analysis and Application”, Louviere J., Hensher D. and Swait J., Cambridge, UK: Cambridge University Press (2^{nd} Printing, 2003), both of which documents are incorporated herein in their entirety by reference. Notwithstanding the foregoing, those skilled in the art would realise that the desired constants may alternatively be estimated using other known methods.

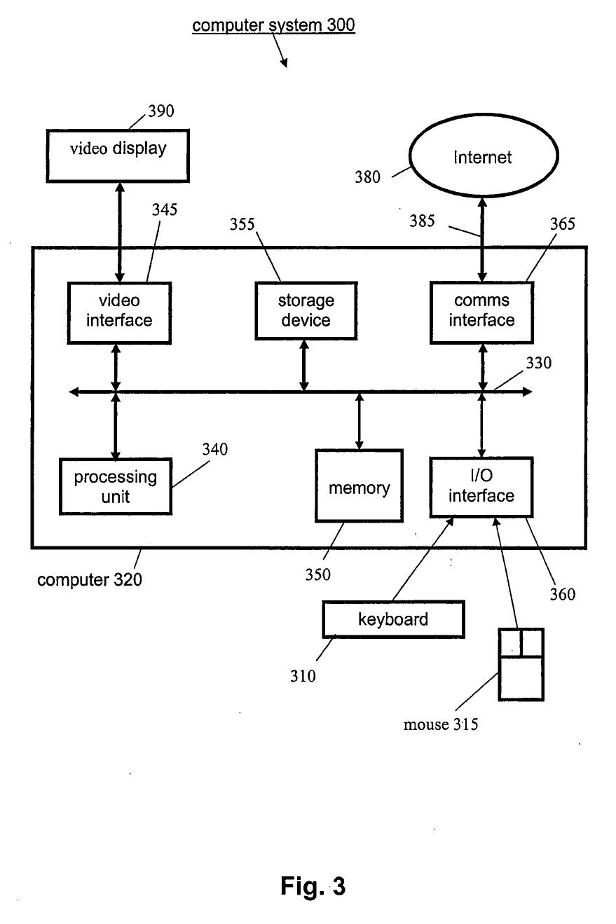

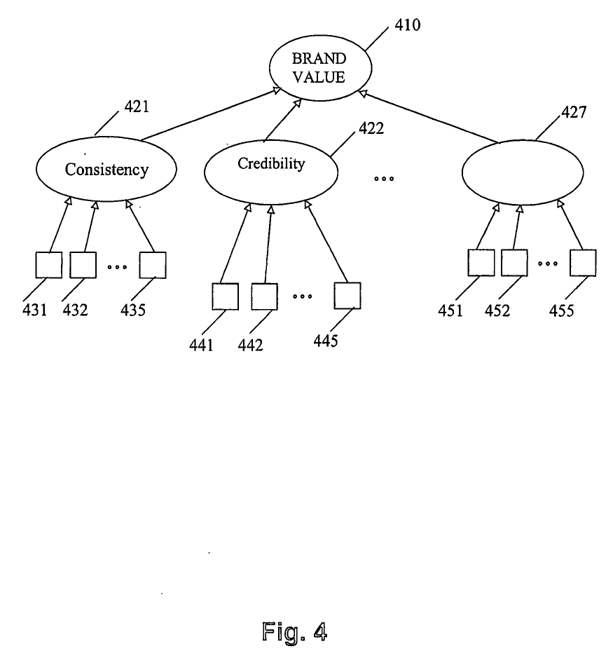

Computation of the choice probabilities may be performed using a custom software program or by way of a mathematical model created using a commonly available spreadsheet program such as Microsoft Excel or Lotus Spreadsheet. In any case, the software may be executed on a computer system such as the computer system shown in FIG. 3 and described hereinafter.

The MNL model can be described for the general case where there are j choice options and it is desired to predict the probability that the i-th option is chosen from a set C of options offered, as follows:

P(i|C)=exp(Vᵢ)/Σⱼexp(Vⱼ) (6)

More specifically, the probability of choosing option 1 can be written as:

P(1|1, 2, . . . , j)=exp(V₁)/[exp(V₁)+exp(V₂)+ . . . +exp(Vⱼ)] (7)

where: V₁, V₂, . . . , V_{J} can be expressed as:

V₁=α₁−α₂(X₁),

V₂=β₁−β₂(X₂),

. . . ,

Vⱼ=γ₁−γ₂(Xj), and
α₁, α₂, β₁, β₂, γ₁, γ₂ are constants that are estimated from the choice data, which correspond to the constants in the equations for each of the j choice options, X₁, X₂ and Xⱼ are features of each option (e.g., the price of each option, the colour of each option, etc), and
“exp” is the exponential operator, or in words, “e raised to the x power”,

Thus, the MNL model may be expressed as:

P(i|C)=Vᵢ−K_{C} (8)

where:
K_{C} is a constant that is associated with each of the choice sets.

The MNL model may be linearised (i.e., made into a linear model) by taking the natural logarithm (Ln) of both sides of equation 8, as shown in equation 9 below:

Ln[P(i|C)]=λ₁ᵢ−λ₂ᵢ(Xᵢ)−K_{C}, (9)
where:
   the terms in the equations are as described hereinbefore but are now subscripted to indicate that the i-th choice option (e.g., an airline) has its own unique option (brand) constant (λ₁ᵢ) and price slope (or fare slope in the case of an airline) (−λ₂ᵢ),
   Ln represents the natural logarithm (base e, the natural constant), and
   K_{C} is a constant that is associated with each of the choice sets.

A brand constant may be defined as the utility associated with a brand and is derived using choice model estimation based on the number of times that a particular brand is chosen in a choice experiment, with all other variables remaining constant. This means that the number of times that a brand is chosen is independent of the prices or features of that brand and thus provides an intrinsic value of the brand to consumers.

A price slope may be defined as the rate of change in utility of a brand for a one unit change in price.

### Calculating Equity

The equity value of a brand can be determined using measures of willingness-to-pay (WTP) derived from consumer welfare theory in economics or an equivalent method based on equalisation prices. Equalisation prices (EP) are those prices that make the share of each brand in a market equal. Thus, in a market or market segment of J brands, equalisation prices (EPs) are those prices that set the market share associated with each of the J brands to 1/J. Equivalently, EPs are those prices that set the utilities associated with each of the J brands equal to zero. Thus, for all i=1 to I:

Utility of Brandᵢ−(Price Slope of Brandᵢ×Price of Brandᵢ)=0 (10)

and

(EPᵢ)=Utility of Brandᵢ/Price Slope of Brandᵢ (11)

Willingness to pay (WTP) refers to an amount of money that is required to compensate a consumer for a change in one or more features of a good, or for differences in goods. Thus, WTP is often termed “compensating variation”. For example, if a good is changed in some way, say by providing a 3-year warranty instead of a 1-year warranty, WTP is the difference in the amount of dollars that would make a consumer indifferent between a 1 and 3 year warranty. In the case of brand equity, WTP refers to the dollar value of the difference in two (or more) brands, while holding all the features of those brands constant. Thus, if two brands A and B offered exactly the same functional product features, WTP represents the dollar value of the difference that consumers would be willing to pay to have A compared with B when all features are the same. Thus:

WTP=(Utility of Reference Brand−Utility of Brandᵢ)/Price Slope of Brandᵢ (12)

WTP may be calculated from the results of a choice modeling exercise, as shown in the examples presented hereinafter.

### Measuring and Tracking Brand Equity

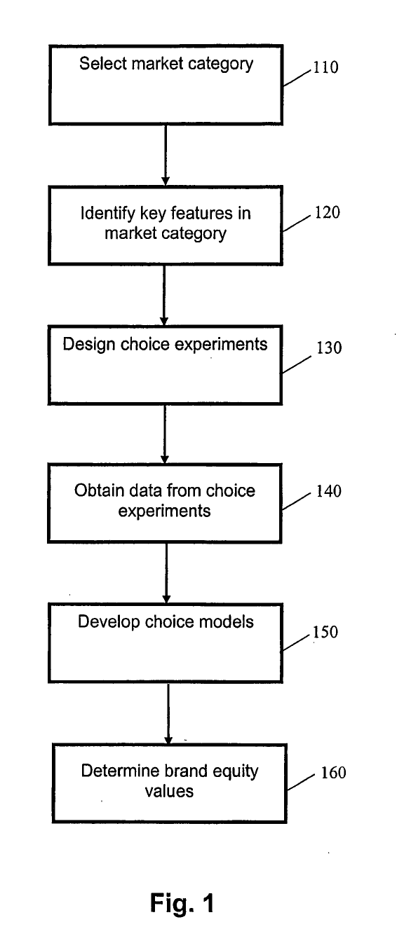

FIG. 1 shows a flow diagram of a method for measuring and tracking brand equity. At step 110, at least one market category is selected. Such categories may relate to a specific type of product or range of products (e.g., retailers, banks, airlines, petrol producers, hire cars, etc.). Key features that drive consumer choices in the at least one market category are identified at step 120. At step 130, choice experiments are designed based on the at least one market category selected in step 110 and the key features identified in step 120. The choice experiments may also be based on a relevant range of levels assigned to each of the features to account for past, present and likely future category variations. Brand equity construct questions and/or other personal characteristic questions may also be designed and an approach to assigning choice sets and brand equity questions to samples may be developed.

At step 140, data is obtained from the choice experiments. The data may be obtained by administering surveys based on the choice experiments to appropriate random samples. The surveys may be administered and the data collected via the World Wide Web (WWW). The data from the choice experiments may be supplemented with survey data that measures key brand equity concepts such as credibility, consistency and quality. Choice models are developed from the collected data at step 150. Results from the choice models are used to calculate brand equity and/or willingness to pay values at step 150. The brand equity and/or willingness to pay values may be used to generate a brand equity index, which may be disseminated to selected parties and/or published (e.g., in newspapers or periodicals). The brand equity and/or willingness to pay values may be stored in one or more databases or used in decision support systems to provide valueadded services for brand owners or other parties. Customised reports may also be generated from the data and made available to brand owners or other parties.

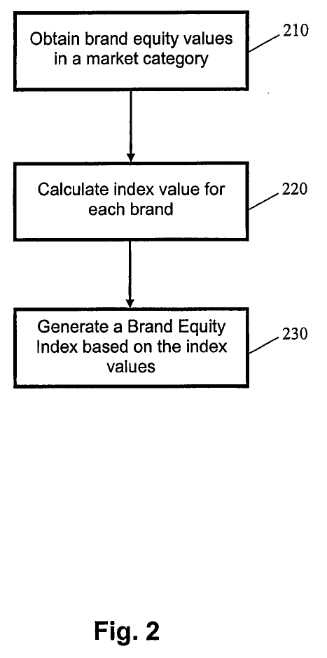

FIG. 2 shows a flow diagram of another method for measuring and tracking brand equity. Brand equity values relating to brands in a market category are obtained at step 210. At step 220, an index value is calculated for each brand equity value. A brand equity index is generated at step 230, which is based on the index values calculated in step 220.

The brand equity index preferably comprises relative values, which are each associated with a corresponding brand in the market category and are each representative of a difference between the brand equity value of the corresponding brand and a reference brand equity value for the market category. The reference brand equity value may comprise an average value of the brand equity values of brands in the market category. Each of the relative values represent a premium above or a discount below the average value that will enable a brand corresponding to the relative value to achieve an equal share in the market category. The brand equity values comprise monetary values.

### First Airline Example

Table 1a, hereinafter, shows data resulting from a choice experiment involving three major brands (Qantas, JetStar and Virgin Blue) in the Australian domestic airline market, wherein flights between Sydney and Perth are offered at the prices shown in each of 4 scenarios (called “choice sets”). Each scenario is evaluated by a total of 100 individuals (survey respondents or “panelists”).

TABLE 1a

| Choice | Fares For Sydney to Perth Flights | | | Choices of Flights By Scenario | | | |
|---|---|---|---|---|---|---|---|
| Scenarios | Qantas | Virgin Blue | JetStar | Qantas | Virgin Blue | JetStar | Totals |
| 1 | $599 | $399 | $359 | 50 | 30 | 20 | 100 |
| 2 | $599 | $499 | $459 | 60 | 20 | 20 | 100 |
| 3 | $799 | $399 | $459 | 40 | 50 | 20 | 100 |
| 4 | $799 | $499 | $359 | 45 | 25 | 30 | 100 |

The number of observed choices relating to each airline can be matched up with a fare of a corresponding airline in Table 1a, hereinbefore. Table 1b, hereinafter, shows the number of observed choices in Table 1a that relate to each of the Qantas fares, as well as the natural logarithm of the number of observed choices for each Qantas fare:

TABLE 1b

| | | Natural log of |
|---|---|---|
| Qantas Fares | Qantas Choices | Qantas choices |
| $599 | 50 | 3.912 |
| $599 | 60 | 4.094 |
| $799 | 40 | 3.689 |
| $799 | 45 | 3.807 |

The number of observed choices in Table 1b may be analysed to estimate a choice model. In the present example, the data in Table 1b and a commercially available computer program called LOGIT™, available from Salford Systems, Inc., of 8880 Rio San Diego Drive, Ste. 1045, San Diego, Calif. 92108, United States of America, were used to estimate the constants for the following equations based on equation 9, hereinbefore:

Utility(Qantas)=1.60−0.0028(Qantas Fare)

Utility(Virgin)=2.40−0.0072(Virgin Fare)

Utility(JetStar)=0−0.0028(JetStar Fare)

The brand constants (λ₁ᵢ) and price slopes (λ₂ᵢ) were estimated directly from the data in Table 1b using the technique of maximum likelihood estimation. Maximum likelihood estimation finds a set of parameters that maximises the likelihood of the model given the data. As maximum likelihood estimation does not involve linearisation of the LOGIT model, the constants K_{c} in equation 9 are irrelevant. However, the constants K_{c} in equation 9 are relevant when other estimation techniques such as weighted least squares estimation are applied to a linearised version of the model.

The LOGIT™ computer program was executed using the input data and script files contained in Appendix 1 (items no's. 1, 2 and 3), hereinafter, on a computer system such as the computer system 300 shown in FIG. 3 and described hereinafter. Appendix 1 also contains an output file (item no. 4) generated by the LOGIT™ computer program.

Those skilled in the art would appreciate that numerous other commercially available software programs may alternatively be used to estimate the constants for the foregoing and other models. Furthermore, the constants may be estimated using applications developed for mathematical modeling software packages such as Matlab™ or Gauss™, which may also be executed on a computer system such as the computer system 300 shown in FIG. 3 and described hereinafter.

The implied WTP for each airline is calculated by setting the utility in each of the foregoing estimated equations to zero as per equation 12:

Equity(Qantas)=1.60/0.0028=$571

Equity(Virgin Blue)=2.40/0.0072=$333

Equity(JetStar)=0/0.0028=$0

Average equity in this market segment or category:

=($571+$333+$0)/3

=$301

The equity differences relative to the category average are:

| | |
|---|---|
| Qantas | $571 − $301 = $270 |
| Virgin Blue | $333 − $301 = $32 |
| JetStar | $0 − $301 = −$301 |

A Brand Equity Index for this market segment or category may be generated by calculating the percentage differences of the brand equity values above or below the average value in the segment or category as follows:

| | |
|---|---|
| Qantas | ($270/$301) * 100 = 89.7% |
| Virgin Blue | ($32/$301) * 100 = 10.6% |
| JetStar | (−$301/$301) * 100 = −100.0% |

According to the foregoing, Qantas is worth 89.7% more than the category average, Virgin Blue is worth 10.6% more than the category average and JetStar is worth 100% less than the category average brand.

A pricing experiment is a simple choice experiment, which comprises M choice options (or brands) that are each assigned a fixed number of price levels typically drawn from the range of prices observed in a past, current and/or expected future market. Consider an airline pricing experiment involving fare offerings by the foregoing three airlines, namely Qantas, Virgin Blue and JetStar. If 4 levels of prices (fares) are assigned for a particular city-pair (e.g., Sydney to Perth), there are 43=64 possible combinations of fares for each airline brand.

Based on equation 5 and the equations relating to utility for the three airlines described hereinbefore, choice model equations for each of the airlines can be generated:

$$\begin{matrix}P ( Qantas \vert Q , V , J ) = \frac{{e}^{( 1.6 - 0.0028 Qantas fare )}}{\begin{matrix}{e}^{( 1.6 - 0.0028 Qantas fare )} + {e}^{( 2.4 - 0.0072 VB fare )} + \\ {e}^{( 0 - 0.0028 JetStar fare )}\end{matrix}} \\ P ( Virgin \vert Q , V , J ) = \frac{{e}^{( 2.4 - 0.0072 VB fare )}}{\begin{matrix}{e}^{( 1.6 - 0.0028 Qantas fare )} + {e}^{( 2.4 - 0.0072 VB fare )} + \\ {e}^{( 0 - 0.0028 JetStar fare )}\end{matrix}} \\ P ( JetStar \vert Q , V , J ) = \frac{{e}^{( 0 - 0.0028 JetStar fare )}}{\begin{matrix}{e}^{( 1.6 - 0.0028 Qantas fare )} + {e}^{( 2.4 - 0.0072 VB fare )} + \\ {e}^{( 0 - 0.0028 JetStar fare )}\end{matrix}}\end{matrix}$$

If, for example, the fares between Sydney and Perth are:

| | |
|---|---|
| Qantas | $700 |
| Virgin Blue | $600 |
| JetStar | $500, |

$$\begin{matrix}P ( Qantas \vert Q , V , J ) = \frac{{e}^{( 1.6 - 0.0028 \times 700 )}}{\begin{matrix}{e}^{( 1.6 - 0.0028 \times 700 )} + {e}^{( 2.4 - 0.0072 \times 600 )} + \\ {e}^{( 0 - 0.0028 \times 500 )}\end{matrix}} \\ = 0.64 \\ Similarly \text{:} \\ P ( Virgin Blue \vert Q , V , J ) = 0.14 , and \\ P ( JetStar \vert Q , V , J ) = 0.23\end{matrix}$$

Solutions of the foregoing equations predict that Qantas will get 64% of the choices, Virgin Blue will get 14% of the choices and JetStar will get 23% of the choices on the Sydney to Perth route.

It is possible to predict how the market share will change if the fare offered by any of the competitors is varied by re-substituting the new fare value in the choice model. Moreover, the choice model may be further developed to include terms representative of other features such as the number of stops, the number of frequent flyer points awarded (if any), whether a hot meal is served, free alcohol, free movies, etc.

### Second Airline Example

In the second airline example presented hereinafter, a fourth option is introduced into the model, namely the option not to travel (N). This option has a single constant associated with it, which may be arbitrarily assumed to equal zero. Suppose that the brand constants, which were 1.6 for Qantas (Q), 2.4 for Virgin Blue(V) and 0 for JetStar(J) in the first airline example, change in this second example experiment to 1.1, 0.8 and 0.5, respectively, but that the fare slopes for each airline remain the same as in the first example. Using the same fares in the first example of $700, $600 and $500, respectively:

$$\begin{matrix}P ( Q \vert Q , V , J , N ) = \frac{{e}^{( 1.1 - 0.0028 \times 700 )}}{\begin{matrix}{e}^{( 1.1 - 0.0028 \times 700 )} + {e}^{( 0.8 - 0.0072 \times 600 )} + \\ {e}^{( 0.5 - 0.0028 \times 500 )} + {e}^{0}\end{matrix}} \\ = 0.23 \\ P ( V \vert Q , V , J , N ) = \frac{{e}^{( 0.8 - 0.0072 \times 600 )}}{\begin{matrix}{e}^{( 1.1 - 0.0028 \times 700 )} + {e}^{( 0.8 - 0.0072 \times 600 )} + \\ {e}^{( 0.5 - 0.0028 \times 500 )} + {e}^{0}\end{matrix}} \\ = 0.02 \\ P ( J \vert Q , V , J , N ) = \frac{{e}^{( 0.5 - 0.0028 \times 500 )}}{\begin{matrix}{e}^{( 1.1 - 0.0028 \times 700 )} + {e}^{( 0.8 - 0.0072 \times 600 )} + \\ {e}^{( 0.5 - 0.0028 \times 500 )} + {e}^{0}\end{matrix}} \\ = 0.22 \\ P ( N \vert Q , V , J , N ) = \frac{{e}^{( 0 )}}{\begin{matrix}{e}^{( 1.1 - 0.0028 \times 700 )} + {e}^{( 0.8 - 0.0072 \times 600 )} + \\ {e}^{( 0.5 - 0.0028 \times 500 )} + {e}^{0}\end{matrix}} \\ = 0.54\end{matrix}$$

The resulting choice shares are 23% (Qantas), 2% (Virgin Blue), 22% (JetStar) and 54% (not flying).

One method of determining a brand equity value for each of the airline brands is to calculate the implied willingness to pay (WTP) for a particular brand by a consumer. The implied willingness to pay (WTP) for each brand relative to the option of not flying may be obtained by determining the difference in the utility associated with each brand and the utility of not flying:

$$WTP for brand i = \frac{utility of brand i - utility of not flying}{fare slope for brand i}$$

Because the utility of not flying is set to zero for estimation purposes, the above equation reduces to:

$$WTP for brand i = \frac{utility of brand}{fare slope for brand i}$$

Thus:

WTP_{(Qanta)}=1.1/0.0028=$392.86

WTP_{(Virgin Blue)}=0.8/0.0072=$111.11

WTP_{(Jetstar)}=0.5/0.0028=$178.57

Another method of determining a brand equity value for each of the airline brands is to calculate the equalisation price that each competitor (brand) would require to equalise the market category share of each brand. This requires equating each of the brand utilities in the choice model to zero:

Qantas: 1.1−0.0028(Qantas fare)=0
Thus, the Qantas fare=$392.86

Virgin Blue: 0.8−0.0072(Virgin Blue fare)=0
Thus, the Virgin Blue fare=$111.11

JetStar: 0.5−0.0028(JetStar fare)=0
Thus, the JetStar fare=$178.57

Both methods produce the same brand equity values in dollar amounts, which represent the price premiums that each brand can add (or discount) to obtain an equal market share to the other brands. Strong brands can charge significant premiums relative to the average in the market category, whereas weak brands must discount significantly to “buy” an equal amount of market share to that of other brands in the category.

The average value of brand equity in this market category

=($392.86+$111.11+$178.57)/3

=$227.51

Thus, relative to an average brand in the market category, Qantas commands a premium of $392.86−$227.51=$165.35, Virgin Blue has a negative premium of ($111.11−$227.51)=−$116.40 and JetStar has a negative premium of ($178.57−$227.51)=−$48.94.

A Brand Equity Index can be calculated from the results for each airline. For Qantas, the relative premium is $165.35/$227.51=72.7%; for Virgin Blue, the premium is −51.2% and for JetStar, a negative premium or discount of −21.5% is obtained.

### Financial Services Example

This example is based on consumer data that was obtained to evaluate banking and financial services brands in Chicago, United States of America. A range of simple to complex choice models were estimated based on competing branded transaction account options characterised by various account features. Table 2 shows the results for a MNL model estimated from a sample of approximately 350 consumers in Chicago, USA. The study focused on transaction account choices, wherein each consumer evaluated a series of scenarios in which they were offered accounts from a large (national) bank, a mediumsized (national or regional) bank, a small (local) bank and a new, non-traditional financial institution such as American Express or State Farm Insurance. Each consumer was randomly assigned to a version of the survey that contained 16 scenarios (or “choice sets”). The consumers each selected one of the savings account options in each scenario or chose not to do business with any of the banks or financial institutions by keeping their money or cash in a safe place of their choosing. The choice data were used to estimate a statistical choice model with the estimation results shown in Table 2 below. Appendix 2, hereinafter, contains an output file generated by the LOGIT™ computer program described hereinbefore. The content of Table 2 is derived from the output file in Appendix 2.

The first column of Table 2 contains features of transaction accounts found to be significant (e.g., a minimum balance that must be maintained in order not to be charged an account keeping fee) together with estimates of the brand utilities for the bank brand names studied and a key Brand Equity Theory construct found to be significant, namely brand credibility, which was measured on a five category rating scale (credible=+2, +1, 0, −1, −2=not credible).

TABLE 2

| NAME OF VARIABLE TESTED | ESTIMATE | STD ERROR | T-STAT | P OF T-STAT | WTP |
|---|---|---|---|---|---|
| Min Acct Balance (No fee) | −0.000479 | 0.000031 | −15.608800 | 0.000000 | reference |
| Monthly Check Fee | −0.050409 | 0.005726 | −8.803121 | 0.000000 | −$105.24 |
| Per Check Fee | −0.069672 | 0.030197 | −2.307249 | 0.021041 | −$145.45 |
| Interest On Balance | 0.058554 | 0.010104 | 5.795255 | 0.000000 | $122.24 |
| Savings Fee | −0.013856 | 0.005734 | −2.416380 | 0.015676 | −$28.93 |
| Interest On Savings | 0.051397 | 0.010135 | 5.071441 | 0.000000 | $107.30 |
| Own ATM Use Fee | −0.125880 | 0.033820 | −3.722022 | 0.000198 | −$262.80 |
| Credit Card Fee | −0.004140 | 0.000756 | −5.475880 | 0.000000 | −$8.64 |
| Unpaid Balance Fee | −0.017660 | 0.006054 | −2.917130 | 0.003533 | −$36.87 |
| United - no flyer pts | −0.058210 | 0.026848 | −2.168120 | 0.030150 | −$121.52 |
| United - Delta | 0.039645 | 0.030262 | 1.310088 | 0.190166 | $82.77 |
| United - American | −0.050909 | 0.030625 | −1.662323 | 0.096448 | −$106.28 |
| Bank Of America | −0.058187 | 0.046624 | −1.248016 | 0.212025 | −$121.48 |
| Chase Manhattan Bank | 0.000561 | 0.046653 | 0.012023 | 0.990407 | $1.17 |
| Citi-Bank | −0.028371 | 0.047703 | −0.594732 | 0.552023 | −$59.23 |
| Nations Bank | 0.174009 | 0.047886 | 3.633833 | 0.000279 | $363.27 |
| Bank One | −0.253348 | 0.049046 | −5.165540 | 0.000000 | −$528.91 |
| Harris Bank | 0.210413 | 0.047367 | 4.442224 | 0.000009 | $439.28 |
| Northern Trust Bank | 0.081374 | 0.092331 | 0.881327 | 0.378141 | $169.88 |
| Wells Fargo Bank | 0.160116 | 0.091927 | 1.741775 | 0.081548 | $334.27 |
| Midwest Bank | 0.340747 | 0.088861 | 3.834590 | 0.000126 | $711.37 |
| Liberty Federal Bank | 0.322284 | 0.078512 | 4.104922 | 0.000040 | $672.83 |
| Cole Taylor Bank | 0.418205 | 0.076959 | 5.434109 | 0.000000 | $873.08 |
| Pullman Bank | −0.184239 | 0.121019 | −1.522405 | 0.127908 | −$384.63 |
| American Express | 0.443089 | 0.053774 | 8.239836 | 0.000000 | $925.03 |
| Merill Lynch | 0.719608 | 0.054351 | 13.240100 | 0.000000 | $1,502.31 |
| NetBank | 0.513669 | 0.138481 | 3.709304 | 0.000208 | $1,072.38 |
| State Farm | 1.132710 | 0.079766 | 14.200500 | 0.000000 | $2,364.74 |
| Credibility of Large | 2.127155 | 0.164273 | 12.948900 | 0.000000 | $4,440.83 |
| Credibility of Medium | 1.880601 | 0.164482 | 11.433500 | 0.000000 | $3,926.10 |
| Credibility of Small | 0.265525 | 0.170341 | 1.558786 | 0.119047 | $554.33 |
| Credibility of Non-Traditional | 0.012278 | 0.175836 | 0.069828 | 0.944331 | $25.63 |
| Large Bank Category | 1.13000 | 0.04700 | 24.05800 | 0.00000 | $2,359.08 |
| Medium Bank Category | 0.88400 | 0.04900 | 18.10400 | 0.00000 | $1,845.51 |
| Small Bank Category | −0.73100 | 0.06900 | −10.67100 | 0.00000 | −$1,526.10 |
| Non-Traditional Category | −0.98500 | 0.08200 | −12.06700 | 0.00000 | −$2,056.37 |

Table 2 represents a relatively more complex MNL model than that used for the airline example described hereinbefore. Notwithstanding, the values in Table 2 were estimated in a similar manner as the constants in the foregoing airline examples, except that a method of maximum likelihood estimation was used. The second column (ESTIMATE) of Table 2 contains estimated constants for respective features, banks or categories listed in the first column. Furthermore, Table 2 contains additional information produced by the LOGIT™ estimation software.

The third column of Table 2 contains values of standard error (STD ERROR) associated with each estimate in the second column. The fourth column of Table 2 contains T-statistic values (T-STAT) that represent the quotient of each estimate and related standard error (i.e., by dividing each estimate in the second column by an associated standard error in the third column). The fifth column of Table 2 contains values representative of the associated probabilities of getting a T-Statistic as large as was obtained (P OF T-STAT), given that the null hypothesis that the feature (variable) has no effect on the choices is true. These values enable evaluation of the statistical significance of each feature, with values of P OF T-STAT smaller than 0.05 typically taken to imply that a respective feature has an impact on the choices that is highly likely to be greater than zero.

Table 2 also contains estimates of WTP for the features of a transaction account as well as WTP values for each bank brand, general categories of bank size and perceived credibility, in the sixth column. As previously noted, these values are obtained by dividing the estimates for each feature, brand and category by a suitable price-related attribute estimate (reference). In the present example, the dollar-denominated minimum monthly account balance to avoid fees is used as a reference. Thus, the column labeled “WTP” in Table 2 lists the estimated willingness-to-pay in minimum monthly account balance equivalent dollars for each feature, brand, category and construct. For example, the WTP to have an account that provides frequent flyer points on United Airlines versus an account that provides no frequent flyer points is approximately $121.52. This can be interpreted to mean that, on average, the consumers in this sample would be willing to keep an extra $121.52 in their account balances each month to have an account that provided United Airlines frequent flyer points. Similarly, consumers in this sample would be willing to keep an extra $121.48 in their account balances to avoid banking with Bank of America. The latter figure illustrates that Bank of America could offset it's negative brand equity by offering United Airlines frequent flyer points.

Table 3 below shows a brand equity index, which is expressed as the percentage brand equity dollar value above or below the mean category average associated with (in this example) each financial institution brand.

TABLE 3

| FINANCIAL | | | | |
|---|---|---|---|---|
| INSTITUTION | | WTP | WTP − μ | (WTP − μ)/μ |
| Bank Of America | | −$121.48 | −$399.03 | −143.77% |
| Chase Manhattan Bank | | $1.17 | −$276.38 | −99.58% |
| Citi-Bank | | −$59.23 | −$336.78 | −121.34% |
| Nations Bank | | $363.27 | $85.72 | 30.89% |
| Bank One | | −$528.91 | −$806.46 | −290.56% |
| Harris Bank | | $439.28 | $161.73 | 58.27% |
| Northern Trust Bank | | $169.88 | −$107.67 | −38.79% |
| Wells Fargo Bank | | $334.27 | $56.72 | 20.44% |
| Midwest Bank | | $711.37 | $433.82 | 156.30% |
| Liberty Federal Bank | | $672.83 | $395.28 | 142.42% |
| Cole Taylor Bank | | $873.08 | $595.53 | 214.57% |
| Pullman Bank | | −$384.63 | −$662.18 | −238.58% |
| American Express | | $925.03 | $647.48 | 233.28% |
| Merill Lynch | | $1,502.31 | $1,224.76 | 441.28% |
| NetBank | | $1,072.38 | $794.83 | 286.37% |
| State Farm | | $2,364.74 | $2,087.19 | 752.00% |
| | SUM | $8,335.37 | | |
| | MEAN(μ) | $277.55 | | |

The WTP values in Table 3 originate from Table 2. The SUM and MEAN values in Table 3 represent the sum of the WTP values in the third column of Table 3 and the quotient of the SUM divided by the number of WTP values in the third column, respectively.

The mean equity value for the market segment or category is subtracted from the dollar-denominated equity values for each brand in the fourth column of Table 3. Finally, the percentage difference relative to the mean category value is calculated for each brand by dividing the values in the fourth column of Table 3 by the mean. The results are contained in the fifth column of Table 3.

The figures in Table 3 indicate that the highest equity is associated with the non-traditional banks, with the State Farm Insurance brand having the highest equity of all ($2,087.19), or 752% above the category average.

### A Brand Equity Index

A brand equity index is calculated as the percentage premium or discount relative to a benchmark price. The benchmark price may be kept secret, thus providing a relative indication only to protect confidentiality. However, individual subscribers to an index can be provided with benchmarked and currency-denominated values for their brand(s) and competitor brands in the category(ies) to which they subscribe. Subscribers can also be provided with detailed reports and/or decision support systems (DSSs) that measure brand features, services, the impact of changes in competitor brand features and services. Such DSSs may focus on market segments or distributions of currency values in the market. Brand equity values are typically tracked quarterly or semi-annually depending on category size. The index may be published on a periodically updated basis, for example, in newspapers, financial or economic journals, on the World Wide Web (WWW) or via television broadcasting.

### Computer Hardware and Software

FIG. 3 is a schematic representation of a computer system 300 that can be used to practice certain or all of the steps of the methods described herein. Specifically, the computer system 300 is provided for executing computer software that is programmed to assist in performing a method for measuring and tracking brand equity as described hereinbefore. The computer software executes under an operating system such as MS Windows XP™ or Linux™ installed on the computer system 300.

The computer software involves a set of programmed logic instructions that may be executed by the computer system 300 for instructing the computer system 300 to perform predetermined functions specified by those instructions. The computer software may be expressed or recorded in any language, code or notation that comprises a set of instructions intended to cause a compatible information processing system to perform particular functions, either directly or after conversion to another language, code or notation.

The computer software program comprises statements in a computer language. The computer program may be processed using a compiler into a binary format suitable for execution by the operating system. The computer program is programmed in a manner that involves various software components, or code means, that perform particular steps of the methods described hereinbefore.

The components of the computer system 300 comprise: a computer 320, input devices 310, 315 and a video display 390. The computer 320 comprises: a processing unit 340, a memory unit 350, an input/output (I/O) interface 360, a communications interface 365, a video interface 345, and a storage device 355. The computer 320 may comprise more than one of any of the foregoing units, interfaces, and devices.

The processing unit 340 may comprise one or more processors that execute the operating system and the computer software executing under the operating system. The memory unit 350 may comprise random access memory (RAM), read-only memory (ROM), flash memory and/or any other type of memory known in the art for use under direction of the processing unit 340.

The video interface 345 is connected to the video display 390 and provides video signals for display on the video display 390. User input to operate the computer 320 is provided via the input devices 310 and 315, comprising a keyboard and a mouse, respectively. The storage device 355 may comprise a disk drive or any other suitable non-volatile storage medium.

Each of the components of the computer 320 is connected to a bus 330 that comprises data, address, and control buses, to allow the components to communicate with each other via the bus 330.

The computer system 300 may be connected to one or more other similar computers via the communications interface 365 using a communication channel 385 to a network 380, represented as the Internet.

The computer software program may be provided as a computer program product, and recorded on a portable storage medium. In this case, the computer software program is accessible by the computer system 300 from the storage device 355. Alternatively, the computer software may be accessible directly from the network 380 by the computer 320. In either case, a user can interact with the computer system 300 using the keyboard 310 and mouse 315 to operate the programmed computer software executing on the computer 320.

The computer system 300 has been described for illustrative purposes. Accordingly, the foregoing description relates to an example of a particular type of computer system suitable for practicing the methods and computer program products described hereinbefore. Other configurations or types of computer systems can be equally well used to practice the methods and computer program products described hereinbefore, as would be readily understood by persons skilled in the art.

### Extensions to Choice Models

As described hereinbefore, the value inherent in a brand may be represented in a choice model based on constructs such as consistency, credibility and quality.

A choice model may be adjusted to more accurately represent and decompose the value inherent in brands. For example, operational characteristics and/or consumer perceptions, attitudes and satisfaction measures may be used to vary the coefficients (β₀ . . . βₖ) of the choice model.

FIG. 4 is a diagram showing an example of how brand value determined from a choice model may be influenced or adjusted based on operational characteristics and/or consumer perceptions, attitudes and satisfaction measures. The brand value 410 is influenced by a series of constructs or dimensions 421 . . . 427, such as brand consistency 421 and brand credibility 422. Survey questions in a construct category relating to product represented by a brand may be asked of persons managing that brand or of consumers of that brand. For example, questions 431 . . . 435, 441 . . . 445 and 451 . . . 455 such as “Does the product deliver what it promises?” 441 and “Are the product claims believable?” 442 may be asked of consumers under the construct or dimension of brand credibility 422. More reliable measures of a particular construct can be obtained by asking multiple questions about the construct, as opposed to a single question, each of which potentially captures slightly different aspects of the construct.

Embodiments of methods, systems and computer program products for measuring and tracking brand equity have been described herein. The foregoing detailed description provides exemplary embodiments only, and is not intended to limit the scope, applicability or configurations of the invention. Rather, the description of the exemplary embodiments provides those skilled in the art with enabling descriptions for implementing an embodiment of the invention. Various changes may be made in the function and arrangement of elements without departing from the spirit and scope of the invention as set forth in the claims hereinafter.

(Australia Only) In the context of this specification, the word “comprising” means “including principally but not necessarily solely” or “having” or “including”, and not “consisting only of”. Variations of the word “comprising”, such as “comprise” and “comprises” have correspondingly varied meanings.

APPENDIX 1
Scripts for LOGIT Run on Airline Example

1. Data file: set up for input to DATA procedure and analysis using
LOGIT. This file is named “AIRLINE1.TXT”.
1 599 399 359 50 1
1 599 399 359 30 2
1 599 399 359 20 3
2 599 499 459 60 1
2 599 499 459 20 2
2 599 499 459 20 3
3 799 399 459 40 1
3 799 399 459 50 2
3 799 399 459 20 3
4 799 499 359 45 1
4 799 499 359 25 2
4 799 499 359 30 3
2. SYSTAT Command script for batch processing of Data file. This file
is named “AIRLINE1.CMD”.
get airline1.txt
sa airline1
lrecl=996
input sets,qf,vf,jf,tots,alt
let z=0
run
qu
3. LOGIT command script for analyzing AIRLINE1.TXT, estimating the
parameters of the choice model for the data and outputting the results
to an output text file called “AIR1MNL.OUT”.
us airline1
output air1mnl.out
format=5
charset=generic
ncat=3
weight=tots
model alt=constant+qfare[qf z z]+vfare[z vf z]+jfare[z z jf]
estimate
qu
4. The LOGIT output file named “AIR1MNL.OUT”.
CONDITIONAL LOGIT
==========================
CONDITIONAL LOGIT ANALYSIS
==========================
DEPENDENT VARIABLE: ALT
ANALYSIS IS WEIGHTED BY TOTS
SUM OF WEIGHTS = 410.00000
INPUT RECORDS: 12
RECORDS IN RAM FOR ANALYSIS: 12
SAMPLE SPLIT
============

| | | | WEIGHTED | WEIGHTED |
|---|---|---|---|---|
| CATEGORY | COUNT | % | COUNT | % |
| 1 | 4 | 0.33333 | 195.00000 | 0.47561 |
| 2 | 4 | 0.33333 | 125.00000 | 0.30488 |
| 3 | 4 | 0.33333 | 90.00000 | 0.21951 |
| | 12 | | 410.00000 | |

| | | |
|---|---|---|
| L-L AT ITER | 1 IS | −450.43104 |
| L-L AT ITER | 2 IS | −419.22070 |
| L-L AT ITER | 3 IS | −419.01971 |
| L-L AT ITER | 4 IS | −419.01969 |

CONVERGENCE ACHIEVED
RESULTS OF ESTIMATION
=====================
LOG LIKELIHOOD: −419.01969

| PARAMETER | ESTIMATE | S.E. | T-RATIO | P-VALUE |
|---|---|---|---|---|
| 1 QFARE | −0.00280 | 0.00101 | −2.77525 | 0.00552 |
| 2 VFARE | −0.00723 | 0.00223 | −3.23965 | 0.00120 |
| 3 JFARE | −0.00279 | 0.00243 | −1.14773 | 0.25108 |
| 4 CONSTANT | 1.60054 | 1.27032 | 1.25995 | 0.20769 |
| 4 CONSTANT | 2.39949 | 1.46378 | 1.63924 | 0.10116 |

5 ESTIMABLE PARAMETERS.
LOG LIKELIHOOD OF CONSTANTS ONLY MODEL = LL(0) = −429.86743
2*[LL(N) − LL(0)] = 21.69549 WITH 3 DOF, CHI-SQ P-VALUE = 0.00008
MCFADDEN'S RHO-SQUARED = 0.02524

APPENDIX 2
CONDITIONAL LOGIT

==========================
CONDITIONAL LOGIT ANALYSIS
==========================
DEPENDENT VARIABLE: Y1
ANALYSIS IS WEIGHTED BY WT
SUM OF WEIGHTS = .619200E+04
INPUT RECORDS: 6192
RECORDS IN RAM FOR ANALYSIS: 6192
SAMPLE SPLIT
============

| | | | WEIGHTED | WEIGHTED |
|---|---|---|---|---|
| CATEGORY | COUNT | % | COUNT | % |
| 1 | 2445 | 0.394864341 | .244102E+04 | 0.394221098 |
| 2 | 2198 | 0.354974160 | .215942E+04 | 0.348743677 |
| 3 | 369 | 0.059593023 | .375059E+03 | 0.060571475 |
| 4 | 512 | 0.082687339 | .539154E+03 | 0.087072687 |
| 5 | 668 | 0.107881137 | .677349E+03 | 0.109391062 |
| | 6192 | | .619200E+04 | |

| | |
|---|---|
| L-L AT ITER | 1 IS −.996564E+04 |
| L-L AT ITER | 2 IS −.798198E+04 |
| L-L AT ITER | 3 IS −.789127E+04 |
| L-L AT ITER | 4 IS −.788843E+04 |
| L-L AT ITER | 5 IS −.788842E+04 |
| L-L AT ITER | 6 IS −.788842E+04 |

CONVERGENCE ACHIEVED
RESULTS OF ESTIMATION
=====================
LOG LIKELIHOOD: −.788842E+04

| PARAMETER | ESTIMATE | S.E. | T-RATIO | P-VALUE |
|---|---|---|---|---|
| 1 MINBAL0 | −0.000478551 | 0.000030659 | −.156088E+02 | 0.000000000 |
| 2 MCHKFEE0 | −0.050409236 | 0.005726292 | −8.803120613 | 0.000000000 |
| 3 PCHKFEE0 | −0.069671682 | 0.030196859 | −2.307249297 | 0.021040926 |
| 4 INTPAID0 | 0.058553621 | 0.010103717 | 5.795255386 | 0.000000007 |
| 5 SAVEFEE0 | −0.013855984 | 0.005734191 | −2.416379938 | 0.015675694 |
| 6 INTRATE0 | 0.051397213 | 0.010134638 | 5.071440519 | 0.000000396 |
| 7 OWNATM0 | −0.125880157 | 0.033820365 | −3.722022476 | 0.000197633 |
| 8 CREDITD0 | −0.004139701 | 0.000755988 | −5.475880314 | 0.000000044 |
| 9 UNPAID0 | −0.017660347 | 0.006054014 | −2.917130371 | 0.003532680 |
| 10 FLYERPT0 | −0.058210197 | 0.026848235 | −2.168120031 | 0.030149557 |
| 11 FLYERPT1 | 0.039645323 | 0.030261566 | 1.310088287 | 0.190165971 |
| 12 FLYERPT2 | −0.050909195 | 0.030625333 | −1.662322977 | 0.096448033 |
| 13 LBANKS1 | −0.058187137 | 0.046623708 | −1.248016063 | 0.212025175 |
| 14 LBANKS2 | 0.000560894 | 0.046652754 | 0.012022740 | 0.990407472 |
| 15 LBANKS3 | −0.028370644 | 0.047703251 | −0.594731876 | 0.552022711 |
| 16 MBANKS1 | 0.174008622 | 0.047885701 | 3.633832643 | 0.000279242 |
| 17 MBANKS2 | −0.253347580 | 0.049045710 | −5.165540067 | 0.000000240 |
| 18 MBANKS3 | 0.210413370 | 0.047366669 | 4.442224306 | 0.000008929 |
| 19 SBANKS1 | 0.081374108 | 0.092331342 | 0.881327035 | 0.378140837 |
| 20 SBANKS2 | 0.160115931 | 0.091926875 | 1.741774978 | 0.081547827 |
| 21 SBANKS3 | 0.340747056 | 0.088861412 | 3.834589719 | 0.000125773 |
| 22 NBANKS1 | 0.322283758 | 0.078511539 | 4.104922211 | 0.000040481 |
| 23 NBANKS2 | 0.418204812 | 0.076959219 | 5.434109375 | 0.000000055 |
| 24 NBANKS3 | −0.184239264 | 0.121018566 | −1.522404952 | 0.127907644 |
| 25 LCREDIBILITY | 0.443089174 | 0.053774031 | 8.239835656 | 0.000000000 |
| 26 MCREDIBILITY | 0.719608422 | 0.054350758 | .132401E+02 | 0.000000000 |
| 27 SCREDIBILITY | 0.513668872 | 0.138481195 | 3.709304143 | 0.000207829 |
| 28 NCREDIBILITY | 1.132709861 | 0.079765669 | .142005E+02 | 0.000000000 |
| 29 CONSTANT | 2.127155350 | 0.164273295 | .129489E+02 | 0.000000000 |
| 29 CONSTANT | 1.880601183 | 0.164481831 | .114335E+02 | 0.000000000 |
| 29 CONSTANT | 0.265524581 | 0.170340602 | 1.558786202 | 0.119046991 |
| 29 CONSTANT | 0.012278282 | 0.175835991 | 0.069828034 | 0.944330533 |

32 ESTIMABLE PARAMETERS.
LOG LIKELIHOOD OF CONSTANTS ONLY MODEL = LL(0) = −.841355E+04
2*[LL(N) − LL(0)] = .105027E+04 WITH 28 DOF, CHI-SQ P-VALUE = 0.000000000
MCFADDEN'S RHO-SQUARED = 0.062415521

1. A method for measuring and tracking brand equity, said method comprising the steps of:
selecting at least one market category;
identifying key features in said at least one market category;
designing choice experiments based on a plurality of brands in said at least one market category and said key features;
obtaining data relating to said plurality of brands using said choice experiments;
developing choice models from said data; and
determining a brand equity value for each of said plurality of brands using said choice models.

2. The method of claim 1, wherein said brand equity values comprise monetary values.

3. The method of claim 1, wherein said data is obtained by consumer surveys conducted via the World Wide Web (WWW).

4. The method of claim 1, comprising the further step of generating a brand equity index based on said brand equity values, wherein said brand equity index comprises a plurality of relative values, each said relative value associated with a corresponding brand equity value and representative of a difference between said corresponding brand equity value and a reference brand equity value for said market category.

5. The method of claim 4, wherein said reference brand equity value comprises an average value of the brand equity values of a plurality of brands in said market category.

6. The method of claim 5, wherein each said relative value represents a premium above or a discount below said average value that will enable a brand corresponding to said relative value to achieve an equal share in said market category.

7. The method of claim 4, wherein said reference brand equity value remains secret from recipients of said brand equity index.

8. A method for measuring and tracking brand equity, said method comprising the steps of:
obtaining a brand equity value for each of a plurality of brands in a market category;
calculating an index value for each of said plurality of brands, each said index value representative of a difference between a corresponding brand equity value and a reference brand equity value for said market category; and
generating a brand equity index for said market category based on said index values.

9. The method of claim 8, wherein said brand equity values comprise monetary values.

10. The method of claim 8, wherein said reference brand equity value comprises an average value of the brand equity values of said plurality of brands in said market category.

11. The method of claim 8, wherein said step of obtaining a brand equity value for each of a plurality of brands in a market category comprises the sub-steps of:
selecting a market category;
identifying key features in said market category;
designing choice experiments based on a plurality of brands in said market category and said key features;
obtaining data relating to said plurality of brands using said choice experiments;
developing choice models from said data; and
determining a brand equity value for each of said plurality of brands using said choice models.

12. A computer program product comprising a computer readable medium comprising a computer program recorded therein for measuring and tracking brand equity, said computer program product comprising:
computer program code for identifying key features in at least one market category;
computer program code for designing choice experiments based on a plurality of brands in said at least one market category and said key features;
computer program code for obtaining data relating to said plurality of brands using said choice experiments;
computer program code for generating choice models from said data; and
computer program code for determining a brand equity value for each of said plurality of brands using said choice models.

13. The computer program product of claim 12, wherein said brand equity values comprise monetary values.

14. The computer program product of claim 12, wherein said computer program code for obtaining data comprises computer program code for conducting consumer surveys via the World Wide Web (WWW).

15. The computer program product of claim 12, further comprising computer program code for generating a brand equity index based on said brand equity values, wherein said brand equity index comprises a plurality of relative values, each said relative value associated with a corresponding brand equity value and representative of a difference between said corresponding brand equity value and a reference brand equity value for said market category.

16. The computer program product of claim 15, wherein said reference brand equity value comprises an average value of the brand equity values of a plurality of brands in said market category.

17. The computer program product of claim 16, wherein each said relative value represents a premium above or a discount below said average value that will enable a brand corresponding to said relative value to achieve an equal share in said market category.

18. The computer program product of claim 15, wherein said reference brand equity value remains secret from recipients of said brand equity index.

19. A computer program product comprising a computer readable medium comprising a computer program recorded therein for measuring and tracking brand equity, said computer program product comprising:
computer program code for obtaining a brand equity value for each of a plurality of brands in a market category;
computer program code for calculating an index value for each of said plurality of brands, each said index value representative of a difference between a corresponding brand equity value and a reference brand equity value for said market category; and
computer program code for generating a brand equity index for said market category based on said index values.

20. The computer program product of claim 19, wherein said brand equity values comprise monetary values.

21. The computer program product of claim 19, wherein said reference brand equity value comprises an average value of the brand equity values of said plurality of brands in said market category.

22. The computer program product of claim 19, wherein said computer program code for obtaining a brand equity value for each of a plurality of brands in a market category comprises:
computer program code for identifying key features in a selected market category;
computer program code for designing choice experiments based on a plurality of brands in said market category and said key features;
computer program code for obtaining data relating to said plurality of brands using said choice experiments;
computer program code for generating choice models from said data; and
computer program code for determining a brand equity value for each of said plurality of brands using said choice models.

23. A system for measuring and tracking brand equity, comprising:
a communications interface for transmitting and receiving data;
a memory unit for storing data and instructions to be performed by a processing unit; and
a processing unit coupled to said communications interface and said memory unit, said processing unit programmed to:
identifying key features in at least one selected market category;
generate choice experiments based on a plurality of brands in said at least one market category and said key features;
obtain data relating to said plurality of brands using said choice experiments;
generate choice models from said data; and
determine a brand equity value for each of said plurality of brands using said choice models.

24. The system of claim 23, wherein said brand equity values comprise monetary values.

25. The system of claim 22, wherein said processing unit is programmed to obtain said data using consumer surveys conducted via the World Wide Web (WWW).

26. The system of claim 22, wherein said processing unit is further programmed to generate a brand equity index based on said brand equity values, wherein said brand equity index comprises a plurality of relative values, each said relative value associated with a corresponding brand equity value and representative of a difference between said corresponding brand equity value and a reference brand equity value for said market category.

27. The system of claim 26, wherein said reference brand equity value comprises an average value of the brand equity values of a plurality of brands in said market category.

28. The system of claim 27, wherein each said relative value represents a premium above or a discount below said average value that will enable a brand corresponding to said relative value to achieve an equal share in said market category.

29. The system of claim 26, wherein said reference brand equity value remains secret from recipients of said brand equity index.

30. A system for measuring and tracking brand equity, comprising:
a communications interface for transmitting and receiving data;
a memory unit for storing data and instructions to be performed by a processing unit; and
a processing unit coupled to said communications interface and said memory unit, said processing unit programmed to:
obtain a brand equity value for each of a plurality of brands in a market category;
calculate an index value for each of said plurality of brands, each said index value representative of a difference between a corresponding brand equity value and a reference brand equity value for said market category; and
generate a brand equity index for said market category based on said index values.

31. The system of claim 30, wherein said brand equity values comprise monetary values.

32. The system of claim 30, wherein said reference brand equity value comprises an average value of the brand equity values of said plurality of brands in said market category.

33. The system of claim 30, wherein said processing unit is further programmed to:
identify key features in a selected market category;
design choice experiments based on a plurality of brands in said market category and said key features;
obtain data relating to said plurality of brands using said choice experiments;
generate choice models from said data; and
determine a brand equity value for each of said plurality of brands using said choice models.

34. The method of claim 1, comprising the further step of adjusting said choice models based on answers to survey questions relating to product said brand equity value is representative of.

35. The computer program product of claim 12, further comprising computer program code for adjusting said choice models based on answers to survey questions relating to product said brand equity value is representative of.

36. The system of claim 23, wherein said processing unit is further programmed to adjust said choice models based on answers to survey questions relating to product said brand equity value is representative of.

37. The method of claim 11, comprising the further step of adjusting said choice models based on answers to survey questions relating to product said brand equity value is representative of.

38. The computer program product of claim 22, further comprising computer program code for adjusting said choice models based on answers to survey questions relating to product said brand equity value is representative of.

39. The system of claim 30, wherein said processing unit is further programmed to adjust said choice models based on answers to survey questions relating to product said brand equity value is representative of.
